(19) United States
(12) Patent Application Publication
(10) Pub. No.: US 2010/0299736 A1
(43) Pub. Date: Nov. 25, 2010

(54) AUTOMATED SESSION ADMISSION

(75) Inventors: John H. Yoakum, Cary, NC (US); Philip Edholm, Pleasanton, CA (US)

Correspondence Address: WITHROW & TERRANOVA, P.L.L.C., 100 REGENCY FOREST DRIVE, SUITE 160, CARY, NC, 27518, US

(73) Assignee: NORTEL NETWORKS LIMITED, St. Laurent (CA)

(21) Appl. No.: 12/540,030

(22) Filed: Aug. 12, 2009

Related U.S. Application Data
(63) Continuation-in-part of application No. 10/931,857, filed on Sep. 1, 2004, now abandoned.

(51) Int. Cl. G06F 15/16; H04L 9/32; G06F 21/00

(52) U.S. Cl. 726/7; 709/227

(57) ABSTRACT

The present invention allows a first communication client, which is initiating a communication session, to include admission information in a session request used to establish the communication session in a regular call or conference scenario. The session request is intended to trigger a communication session between the first communication client and another communication client, which is associated with a telephony endpoint or a conferencing system having a communication client. The receiving communication client will use the admission information provided in the session request to determine whether the session is authorized. If authorized, the receiving communication client will either establish the communication session or allow the communication session to be established, as the situation dictates.

### CROSS-REFERENCE TO RELATED APPLICATIONS

This application is a continuation-in-part of U.S. application Ser. No. 10/931,857, filed on Sep. 1, 2004, entitled AUTOMATED CONFERENCE ADMISSION, and is related to U.S. application Ser. No. 10/784,864, filed Feb. 23, 2004, entitled PROVIDING ADDITIONAL INFORMATION WITH SESSION REQUESTS, and U.S. application Ser. No. 10/784,865, filed Feb. 23, 2004, entitled USING ADDITIONAL INFORMATION PROVIDED IN SESSION REQUESTS, the disclosures of which are incorporated herein by reference in their entireties.

### FIELD OF THE INVENTION

The present invention relates to communications, and in particular to providing admission information in a session request that may be used by a remote communication device or application to determine whether to establish the requested session to facilitate basic communications or multi-party conferencing.

### BACKGROUND OF THE INVENTION

Various types of communication sessions, including those based on voice or messaging, are established because two or more parties desire to communicate about a particular subject. The sessions may be regular sessions between two parties or a conference among three or more parties. For conference settings, it is commonplace to require participants to manually enter admission information, including access codes, passwords, or other type of identification information before access to the conference is provided. Further, certain two-party sessions would benefit from requiring the initiating party to provide admission information prior to establishing the session. Unfortunately, manually providing the admission information is cumbersome and requires the parties to keep track of the information. Accordingly, there is a need for a way to automate entry of the admission information in association with establishing a session for a two-party session or a conference session.

### SUMMARY OF THE INVENTION

The present invention allows a first communication client, which is initiating a communication session, to include admission information in a session request used to establish the communication session in a regular call or conference scenario. The session request is intended to trigger a communication session between the first communication client and another communication client, which is associated with a telephony endpoint or a conferencing system having a communication client. The receiving communication client will use the admission information provided in the session request to determine whether the session is authorized. If authorized, the receiving communication client will either establish the communication session or allow the communication session to be established, as the situation dictates.

The admission indicia may include any type or combination of information used to help determine whether to allow the session to be established. For example, the admission information may include authentication information, identification information, passwords, conference access codes, conference identification codes, and the like. The session does not need to be a voice session, but could be an instant messaging session, a video conferencing session including voice, and the like.

Those skilled in the art will appreciate the scope of the present invention and realize additional aspects thereof after reading the following detailed description of the preferred embodiments in association with the accompanying drawing figures.

### BRIEF DESCRIPTION OF THE DRAWING FIGURES

The accompanying drawing figures incorporated in and forming a part of this specification illustrate several aspects of the invention, and together with the description serve to explain the principles of the invention.

FIG. 1 is a block representation of a communication environment according to one embodiment of the present invention.

FIG. 2 is a communication flow diagram according to a first embodiment of the present invention.

FIG. 3 is a communication flow diagram according to a second embodiment of the present invention.

FIG. 4 is a communication flow diagram according to a third embodiment of the present invention.

FIG. 5 is a block representation of a communication client according to one embodiment of the present invention.

FIG. 6 is a block representation of a media application server according to one embodiment of the present invention.

### DETAILED DESCRIPTION OF THE PREFERRED EMBODIMENTS

The embodiments set forth below represent the necessary information to enable those skilled in the art to practice the invention and illustrate the best mode of practicing the invention. Upon reading the following description in light of the accompanying drawing figures, those skilled in the art will understand the concepts of the invention and will recognize applications of these concepts not particularly addressed herein. It should be understood that these concepts and applications fall within the scope of the disclosure and the accompanying claims.

The present invention allows a first communication client to include admission information in a session request used to establish a communication session in a regular call or conference scenario. The session request is intended to trigger a communication session between the first communication client and another communication client, which is associated with a telephony endpoint or a conferencing system. The receiving communication client will use the admission information provided in the session request to determine whether the session is authorized. If authorized, the receiving communication client will either establish the communication session or allow the communication session to be established, as the situation dictates.

The admission indicia may include any type or combination of information used to help determine whether to allow the session to be established. For example, the admission information may include authentication information, identification information, passwords, conference access codes, conference identification codes, and the like. Further, the session does not need to be a voice session, but could be an instant messaging session, a video conferencing session including voice, and the like.

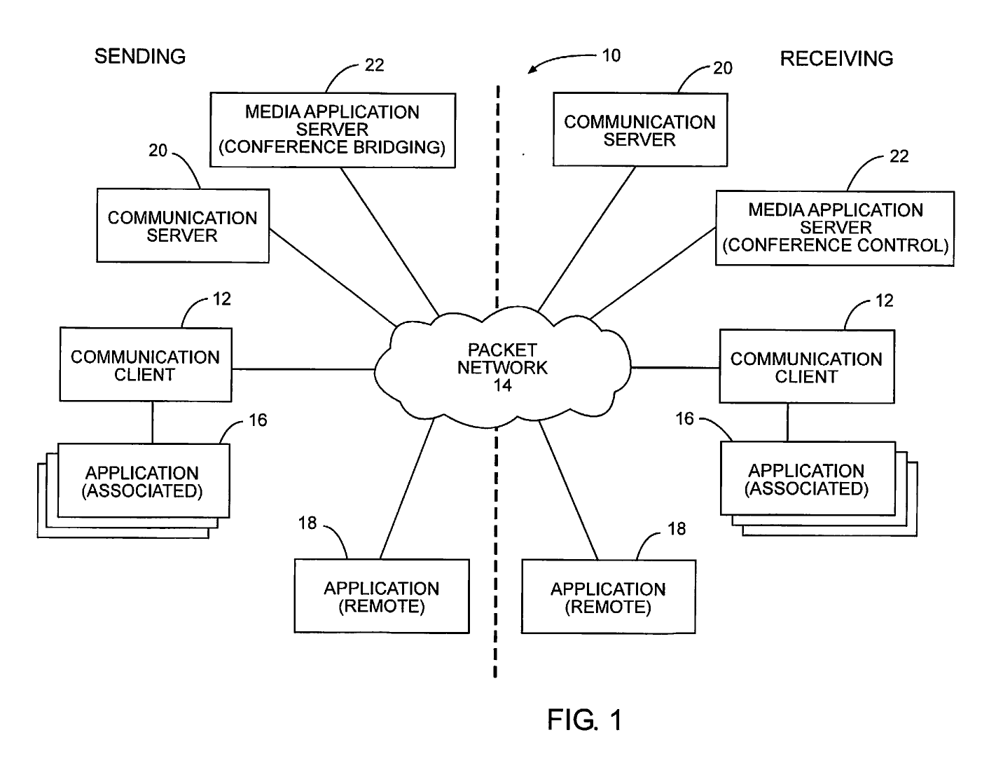

Prior to delving into exemplary communication flows for delivering admission information and instructions in a session request, an overview of an exemplary communication environment according to one embodiment of the present invention is provided. With reference to FIG. 1, an exemplary communication environment 10 is illustrated wherein communication clients 12 can communicate with each other and establish sessions for communication through a packet network 14. The sessions may be established using any type of session establishment protocol, such as the Session Initiation Protocol (SIP). The communication clients 12 may be implemented in various types of communication devices acting as a telephony endpoint, such as personal computers, personal digital assistants (PDAs), telephones, and the like, and may be associated with one or more applications 16, which reside on or are otherwise closely associated with the communication client 12. Other applications 18 may be accessible by the communication client 12 via the packet network 14. These remote applications 18 may provide similar or different functions as the associated applications 16.

Depending on the communication protocol, communication servers 20 may be used to assist in establishing the sessions between the respective communication clients 12. These communication servers 20 may act as proxies, such as a SIP proxy, and play an important role in any necessary signaling or handshaking between the communication clients 12 prior to the communication session being established. Typically, but not necessarily, the communication session is established directly between the communication clients 12, even when session control signaling may involve the communication servers 20. Additionally, one or more media application servers 22 may be provided to assist in establishing various types of media sessions, such as voice, audio, and video sessions and associated conferencing between the communication clients 12 as well as with third party communication clients (not shown). Notably, the media application servers 22 may include communication clients through which sessions may be established along with the capability to bridge the various sessions to support conferencing.

For the purposes of illustration, the communication environment 10 is separated into two sides by a dashed line. Those entities on the left side of the dashed line will be generally modified by the term “sending” and those on the right side of the dashed line will be modified by the term “receiving.” The use of the terms “sending” and “receiving” is only intended to help clarify whether the devices are associated with the communication client 12 sending the session request or receiving the session request for the illustrated embodiments. Accordingly, the sending communication client 12 will send a session request to the receiving communication client 12 to initiate a communication session between the sending and receiving communication clients 12.

In general, the sending associated applications 16 and the sending remote applications 18 will provide the admission information to the sending communication client 12, which will send a session request including the admission information to the receiving communication client 12. In addition to establishing the session with the sending communication client 12, the receiving communication client 12 will process the admission information and interact with the appropriate receiving associated application 16 or receiving remote application 18 to take the appropriate action based on the admission information or instructions provided in the admission information. As noted, the receiving communication client 12 may also interact with the receiving media application server 22 as necessary to support actions involving various types of media-related functions. As will be discussed further below, the session requests may be directed to the media application servers 22, which will assist in establishing conferences among multiple sessions or actually provide bridging for the multiple sessions.

When sending session-related messages between the sending and receiving communication clients 12, the respective sending and receiving communication servers 20 may be used to route these messages. For example, a session request taking the form of a SIP Invite message may be sent from the sending communication client 12 to the sending communication server 20, which will forward the SIP Invite message to the receiving communication server 20, which will in turn forward the SIP Invite message to the receiving communication client 12. For the following communication flow diagrams, the routing of a session request through the communication servers 20 is not illustrated, for conciseness and readability. Those skilled in the art will recognize that various types of communication protocols may or may not require the routing of these session-related messages through the respective communication servers 20, and that the specific routing of these messages is not integral to the concepts of the present invention.

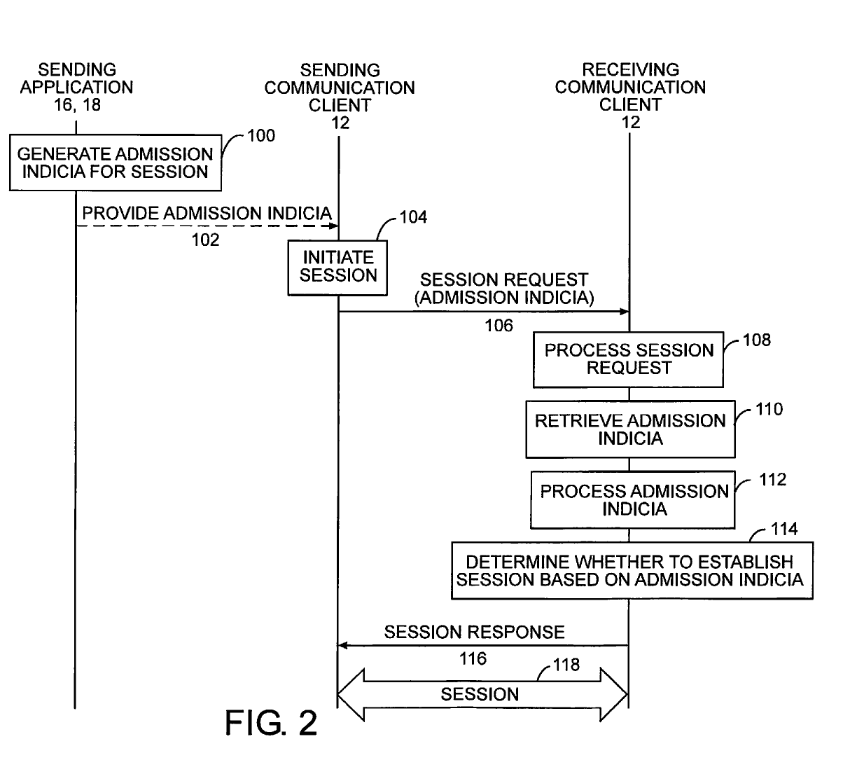

Turning now to FIG. 2, an exemplary communication flow is provided where the admission information is provided in the session request, which is directed toward the receiving communication client 12 and intended to establish a session between the sending and receiving communication clients. The admission information will be automatically extracted and processed by the receiving communication client 12 to determine whether the session should be authorized. Initially, a sending associated or remote application 16, 18 will generate admission information for an upcoming session between the sending and receiving communication clients 12 (step 100). The admission information is provided to the sending communication client 12 (step 102), which will initiate the session (step 104) by sending a session request including the admission information toward the receiving communication client 12 (step 106).

Upon receipt of the session request, the receiving communication client 12 will process the session request (step 108), retrieve the admission information from the session request (step 110), and process the admission information (step 112). The receiving communication client 12 will use the admission information to determine if the requested session is authorized based on certain criteria, which requires proper admission information (step 114). Assuming the session is authorized, the receiving communication client 12 will send a session response back to the sending communication client 12 (step 116), which will establish a communication session between the sending and receiving communication clients 12 (step 118).

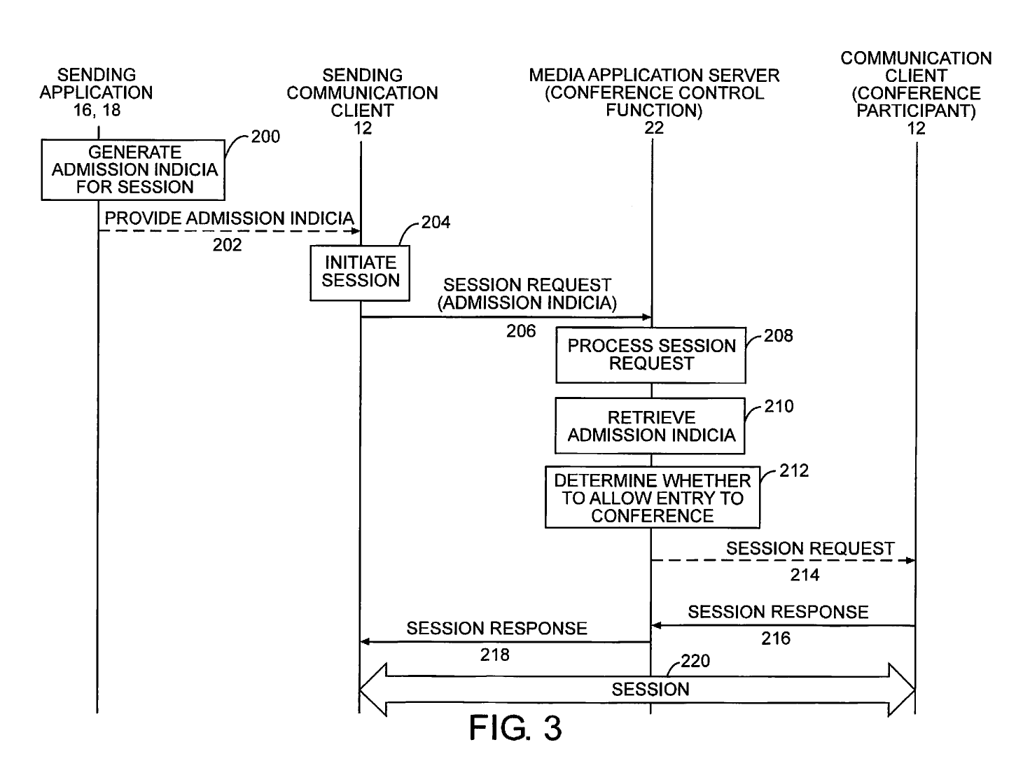

Turning now to FIG. 3, an exemplary communication flow is provided for establishing a session in association with a conference. A media application server 22 is used to control the conference, and will process the admission information to determine whether to allow the session to proceed or otherwise participate in the conference. In this embodiment, the participating communication clients 12 facilitate the actual conferencing. As before, the admission information is provided in the session request.

Initially, a sending associated or remote application 16, 18 will generate admission information for an upcoming session, which is associated with a conference (step 200). The admission information is provided to the sending communication client 12 (step 202), which will initiate the session (step 204) by sending a session request including the admission information toward the media application server 22 associated with the conference, which may be associated with the receiving communication client 12 (step 206).

Upon receipt of the session request, the media application server 22 will process the session request (step 208), retrieve the admission information from the session request (step 210), and process the admission information. The media application server 22 will use the admission information to determine whether to allow entry to the conference (step 212). If entry to the conference is authorized, the media application server will send session requests to any receiving communication clients 12 (step 214), which will respond by sending session responses to the media application server 22 (step 216). The media application server 22 will then send a session response back to the sending communication client (step 218) wherein a session is established between the sending communication client 12 and any receiving communication clients 12, as necessary to effect the conference (step 220). One or more of the participating communication clients 12 will implement the requisite bridging and multicasting functions to allow each of the participants to hear each other in traditional fashion.

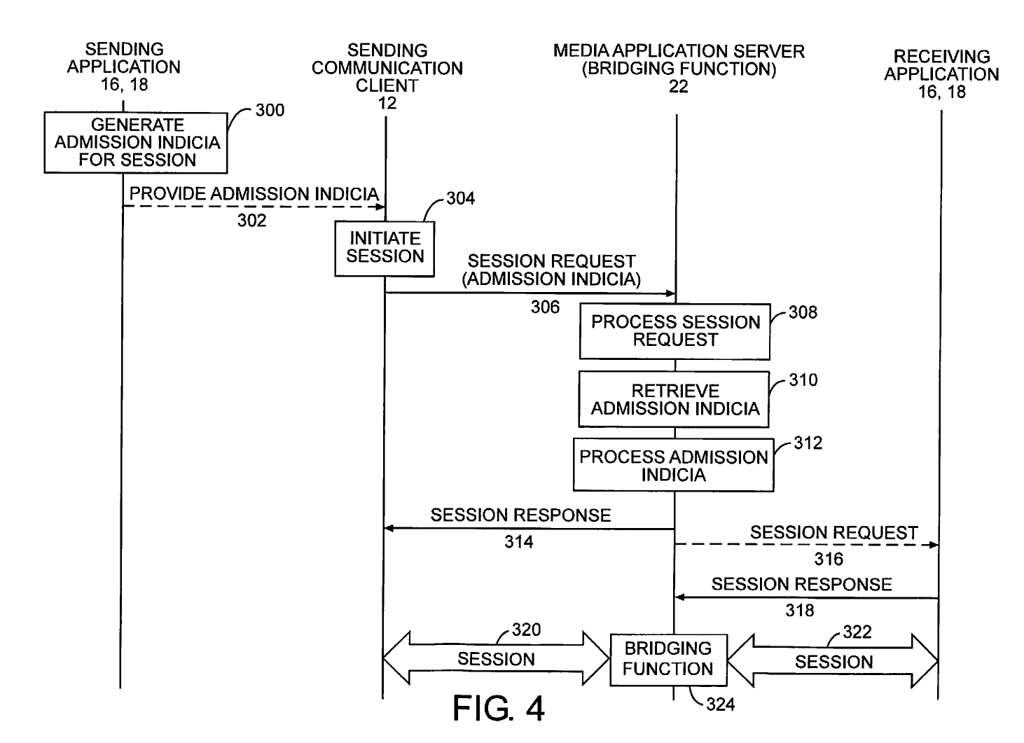

Turning now to FIG. 4, another exemplary communication flow is provided for establishing a session in association with a conference. The media application server 22 is again used to control the conference and will process the admission information to determine whether to allow the session to join the conference. In this embodiment, the media application server 22 will act as an endpoint for the sessions with each of the participating communication clients and provide a bridging function for each of the sessions. The admission information is provided in the session request.

Initially, a sending associated or remote application 16, 18 will generate admission information for an upcoming session, which is associated with a conference (step 300). The admission information is provided to the sending communication client 12 (step 302), which will initiate the session (step 304) by sending a session request including the admission information toward the media application server 22 associated with the conference, which may be associated with the receiving communication client 12 (step 306).

Upon receipt of the session request, the media application server 22 will process the session request (step 308), retrieve the admission information from the session request (step 310), and process the admission information (step 312). The media application server 22 will use the admission information to determine whether to allow entry to the conference. If entry to the conference is authorized, the media application server 22 will also send a session response back to the sending communication client 12 (step 314).

The media application server 22 may process other incoming session requests from other communication clients 12 for the conference. In one embodiment, the media application server 22 may be able to initiate a session with participating communication clients. As illustrated, the media application server 22 may send session requests to any receiving communication clients 12 (step 316), which will respond by sending session responses to the media application server 22 (step 318). At this point, sessions are established with the media application server 22 and each of the participating communication clients 12, including the sending communication client 12 and any receiving communication clients 12 (step 320 and 322). The sessions are bridged by a bridging function (step 324).

In addition to controlling admission to sessions for regular or conferencing environments, the present invention may allow a sending communication client 12 to send a session request to initiate a session with a receiving communication client 12 (or media application server 22), wherein the session request includes additional information configured to allow the receiving communication client 12 to take an action in association with the communication session. The action may be initiated before, during, or after session establishment. Further, the action may take place at any time. The additional information may include context information, which may identify an association related to the subject matter of the session, or a specific instruction or request to take an action in association with the communication session.

In one embodiment, the additional information identifies an association of people, information, or things, which may take many forms. The association is related to the action to be taken. Although not inclusive, the actions to be taken may include providing information to a user, displaying information to a user, recording at least a portion of the communication session, storing information related to the communication session, initiating other sessions with other communication devices, restricting incoming session requests to those related to the existing communication session, obtaining information from a participant in the session, providing information to a participant in the session, accessing web sites, initiating emails, calls, or instant messages, and the like. Accordingly, additional information may be provided in session requests to cause the communication client 12 or media application server 22 receiving the session request to establish the session, as well as take additional actions related to the session or the subject matter to be addressed in the session.

The admission information may be used to identify interested parties, present participants with related information and documents, or trigger related communication events. The actions taken do not need to be immediate. For example, the receiving communication client 12 may recognize the admission information as allowing additional parties related to the admission information to join the session. Thus, when session requests arrive from parties having a relationship to the admission information, the receiving communication client 12 may recognize these participants and allow them to join the session with the initial participants. The additional information may identify the actual context, or provide a pointer to the actual context. In a SIP embodiment, the SIP Invite message will include one or more fields in which the admission or additional information is provided. The receiving communication client 12 will review session requests to determine if this field is populated with admission or additional information.

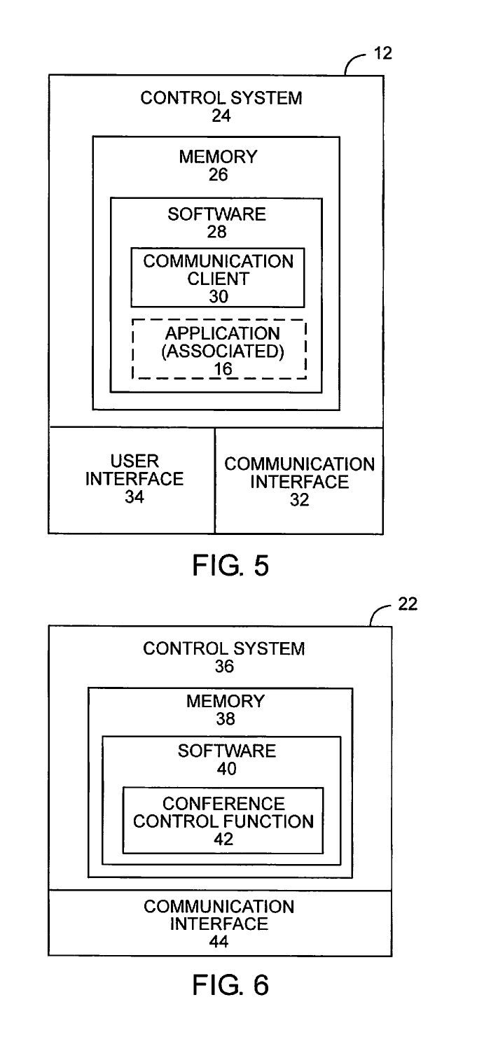

With reference to FIG. 5, an exemplary communication client 12 is illustrated. The communication client 12 may include a control system 24, which is associated with memory 26 having sufficient software 28 to provide the functionality described above. In particular, the software 28 may include a communication client function 30 as well as one or more of the associated applications 16. The control system 24 is also associated with an appropriate communication interface 32 to facilitate sessions and any requisite signaling over the packet network 14. Further, the communication client 12 may include a user interface 34 through which user input is received and information may be displayed to the user. The communication interface 32 and the user interface 34 will vary depending on the nature of the communication client 12.

With reference to FIG. 6, an exemplary application media server 22 is illustrated. The application media server 22 may include a control system 36, which is associated with memory 38 having sufficient software 40 to provide the functionality described above. In particular, the software 40 may include a conference control function 42, which may include a bridging function. The control system 36 is also associated with an appropriate communication interface 44 to facilitate sessions and any requisite signaling over the packet network 14.

Those skilled in the art will recognize improvements and modifications to the preferred embodiments of the present invention. All such improvements and modifications are considered within the scope of the concepts disclosed herein and the claims that follow.

What is claimed is:

1. A method comprising:
a) determining to initiate a communication session with a communication client;
b) providing admission information configured to authorize establishment of the communication session;
c) creating a session request comprising the admission information; and
d) sending the session request over a communication network toward the communication client.

2. The method of claim 1 wherein the admission information is used by the communication client to determine whether to establish the communication session.

3. The method of claim 1 wherein the admission information is used to determine whether to establish the communication session in association with a conference.

4. The method of claim 3 wherein the communication session is one of a plurality of sessions associated with the conference.

5. The method of claim 4 wherein the communication client is a media application server providing a bridging function adapted to bridge the plurality of sessions associated with the conference.

6. The method of claim 3 wherein the session request is received by a media application server, which cooperates with the communication client to control access to the conference.

7. The method of claim 6 wherein the communication client is separate from the media application server.

8. The method of claim 1 wherein the admission information comprises authentication information.

9. The method of claim 1 wherein the admission information comprises identification information.

10. The method of claim 1 wherein the admission information comprises a password.

11. The method of claim 1 wherein the admission information comprises a conference access code.

12. The method of claim 1 wherein the admission information comprises a conference identification code.

13. The method of claim 1 further comprising providing action information configured to allow the communication client to take an action in association with the communication session, wherein the session request is created to include the action information.

14. A system comprising:
a) a communication interface; and
b) a control system associated with the communication interface and adapted to:
i) determine to initiate a communication session with a communication client;
ii) provide admission information configured to authorize establishment of the communication session;
iii) create a session request comprising the admission information; and
iv) send the session request over a communication network toward the communication client.

15. The system of claim 14 wherein the admission information is used by the communication client to determine whether to establish the communication session.

16. The system of claim 14 wherein the admission information is used to determine whether to establish the communication session in association with a conference.

17. The system of claim 16 wherein the communication session is one of a plurality of sessions associated with the conference.

18. The system of claim 17 wherein the communication client is a media application server providing a bridging function adapted to bridge the plurality of sessions associated with the conference.

19. The system of claim 14 wherein the session request is received by a media application server, which cooperates with the communication client to control access to the conference.

20. The system of claim 19 wherein the communication client is separate from the media application server.

21. The system of claim 14 wherein the admission information comprises authentication information.

22. The system of claim 14 wherein the admission information comprises identification information.

23. The system of claim 14 wherein the admission information comprises a password.

24. The system of claim 14 wherein the admission information comprises a conference access code.

25. The system of claim 14 wherein the admission information comprises a conference identification code.

26. The system of claim 14 further comprising providing action information configured to allow the communication client to take an action in association with the communication session, wherein the session request is created to include the action information.

27. A method comprising:
a) receiving a session request comprising admission information configured to authorize establishment of a communication session, the session request originating from a first communication client;
b) determining whether the communication session is authorized based on the admission information; and
c) effecting establishment of the communication session with the first communication client in response to the session request, if the communication session is authorized.

28. The method of claim 27 wherein effecting establishment of the communication session comprises sending a response to the first communication client and facilitating communications with the first communication client.

29. The method of claim 27 wherein effecting establishment of the communication session comprises instructing the first communication client to establish the communication session between the first communication client and a second communication client.

30. The method of claim 29 wherein the communication session is part of a conference with a plurality of communication clients.

31. The method of claim 31 wherein at least one of the plurality of communication clients supports the conference.

32. The method of claim 27 wherein effecting establishment of the communication session comprises sending a response to the first communication client to establish the communication session and the method further comprises establishing additional communication sessions with a plurality of communication clients and bridging the communication sessions to facilitate a conference.

33. The method of claim 27 wherein the admission information comprises authentication information.

34. The method of claim 27 wherein the admission information comprises identification information.

35. The method of claim 27 wherein the admission information comprises a password.

36. The method of claim 27 wherein the admission information comprises a conference access code.

37. The method of claim 27 wherein the admission information comprises a conference identification code.

38. The method of claim 27 wherein action information is included in the session request and the method further comprises taking an action in association with the communication session.

39. A system comprising:
a) a communication interface; and
b) a control system associated with the communication interface and adapted to:
i) receive a session request comprising admission information configured to authorize establishment of a communication session, the session request originating from a first communication client;
ii) determine whether the communication session is authorized based on the admission information; and
iii) effect establishment of the communication session with the first communication client in response to the session request, if the communication session is authorized.

40. The system of claim 39 wherein to effect establishment of the communication session, the control system is further adapted to send a response to the first communication client and facilitate communications with the first communication client.

41. The system of claim 39 wherein to effect establishment of the communication session, the control system is further adapted to instruct the first communication client to establish the communication session between the first communication client and a second communication client.

42. The system of claim 41 wherein the communication session is part of a conference with a plurality of communication clients.

43. The system of claim 42 wherein at least one of the plurality of communication clients supports the conference.

44. The system of claim 39 wherein to effect establishment of the communication session, the control system is further adapted to send a response to the first communication client to establish the communication session, the control system further adapted to establish additional communication sessions with a plurality of communication clients and bridge the communication sessions to facilitate a conference.

45. The system of claim 39 wherein the admission information comprises authentication information.

46. The system of claim 39 wherein the admission information comprises identification information.

47. The system of claim 39 wherein the admission information comprises a password.

48. The system of claim 39 wherein the admission information comprises a conference access code.

49. The system of claim 39 wherein the admission information comprises a conference identification code.

50. The system of claim 39 wherein action information is included in the session request and the control system is further adapted to take an action in association with the communication session.
